(19) United States
(12) Patent Application Publication
(10) Pub. No.: US 2024/0424475 A1
(43) Pub. Date: Dec. 26, 2024

(54) GRAPHENE OXIDE-ZEOLITIC IMIDAZOLATE FRAMEWORK-BASED NANOCOMPOSITE FOR WATER DECONTAMINATION

(71) Applicant: KING FAHD UNIVERSITY OF PETROLEUM AND MINERALS, Dhahran (SA)

(72) Inventors: Sagheer ONAIZI, Dhahran (SA); Muhammad Shariq VOHRA, Dhahran (SA); Waleed K. AL-NOWAISER, Dhahran (SA)

(73) Assignee: KING FAHD UNIVERSITY OF PETROLEUM AND MINERALS, Dhahran (SA)

(21) Appl. No.: 18/340,390

(22) Filed: Jun. 23, 2023

(51) Int. Cl. B01J 20/22; B01J 20/18; B01J 20/28; B82Y 30/00; B82Y 40/00; C01B 39/02

(52) U.S. Cl. CPC B01J 20/226; B01J 20/186; B01J 20/28004; B01J 20/28016; B82Y 30/00; B82Y 40/00; C01B 39/026; B01J 2220/46

(57) ABSTRACT

Aspects of the present disclosure are directed to a nanocomposite. The nanocomposite includes graphene oxide and a zeolitic imidazolate framework, wherein the zeolitic imidazolate framework has a phase I, II, or III structure. The nanocomposite of the present disclosure finds use in water filtration and heavy metal ion removal applications.

### BACKGROUND

### Technical Field

The present disclosure is directed to a zeolite composite, more particularly to a graphene oxide-zeolitic imidazolate framework-based nanocomposite and a method for its use for water decontamination.

### DESCRIPTION OF THE RELATED PRIOR ART

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

An upsurge in industrialization has led to a severe global challenge of water contamination by heavy metals. Lead (Pb²⁺) is one of the most toxic heavy metals since it is highly carcinogenic, non-biodegradable, and tends to bioaccumulate and biomagnify in the ecosystem. Lead usually finds applications in paints, smelting, manufacture of batteries, paper, as well as pulp industries. The lead discharge occurs from different sources such as paint industries, leaded gasoline, and mining sources along with battery manufacturing plants. The leakage of inorganic lead from these sources into water bodies is a prime cause of lead contamination. The permissible limit of lead in drinking water has been set up at 0.05 mg L⁻¹ by the World health organization (WHO). Acute Pb poisoning in human beings may lead to critical damage to the kidneys, liver, and reproductive system. Pb poisoning from environmental exposure also causes headaches, anemia, insomnia, dizziness, irritability, muscle weakness, and hallucination, apart from renal damage. In humans, Pb absorption primarily starts from the lungs and the digestive tract and then circulates in the bloodstream. Thereafter, Pb binding with blood cells takes place, and finally, Pb gets accumulated in the bones.

It is important to eliminate heavy metal ions from contaminated wastewater for the safety of aquatic life and human beings. To address this challenge, various methods have been developed for the removal of contaminants viz., coagulation, ion exchange, chemical precipitation, electrochemical methods, reverse osmosis, and membrane processes [Mahmud, H. N. M. E., Huq, A. O., & binti Yahya, R. (2016). The removal of heavy metal ions from wastewater/aqueous solution using polypyrrole-based adsorbents: a review. RSC Advances, 6(18), 14778-14791]. However, most of these techniques suffer from crucial shortcomings, such as high capital and operational costs, inadequate efficiency at usual discharge levels, and the occurrence of secondary pollution. As opposed to the above limitations, adsorption has come across as a valuable alternative owing to the low cost of adsorbent materials, lower working costs, feasible operational conditions, high efficacy for dilute solutions, and easy handling. Furthermore, adsorption is normally reversible, thus the adsorbents can be simply regenerated via an appropriate desorption method. Furthermore, lead removal via graphene oxide-based nanomaterials is also an appealing option accrediting its favorable properties.

Accordingly, an object of the present disclosure is to develop a nanocomposite of graphene oxide and a metal-organic framework. The nanocomposite has a high lead adsorption capacity at relatively low dosages of adsorbent and can effectively be used as an alternative to conventional adsorbents.

### SUMMARY

In an exemplary embodiment, a nanocomposite is described. The nanocomposite includes graphene oxide, a zeolitic imidazolate framework (ZIF), wherein the zeolitic imidazolate framework has a phase I, II, or III structure.

In some embodiments, the zeolitic imidazolate framework is ZIF-7.

In some embodiments, the zeolitic imidazolate framework has a phase III structure.

In some embodiments, the graphene oxide is less than 5 wt. % of the total mass of the nanocomposite.

In some embodiments, the graphene oxide is about 1.6 wt. % of the total mass of the nanocomposite.

In some embodiments, the nanocomposite has an average particle size of less than 500 nanometers (nm).

In some embodiments, the graphene oxide has an average particle size of less than 100 nm.

In some embodiments, the nanocomposite has a Pb²⁺ ion uptake capacity ranging from 900 milligrams per liter (mg/L) to 5,000 mg/L, where the Pb²⁺ ion uptake capacity is calculated according to:

$${q}_{e} = \frac{( {C}_{i} - {C}_{f} ) V}{m}$$

where Cᵢ and C_{f} are, respectively, the initial and final lead concentrations, V is the sample volume, and m is the amount of graphene oxide-zeolitic imidazolate framework nanocomposite.

In some embodiments, the zeolitic imidazolate framework encases the graphene oxide.

In some embodiments, a method for producing a graphene oxide-zeolitic imidazolate framework nanocomposite includes dissolving an amount of a hydrated zinc nitrate salt in methanol to produce a first solution; adding graphene oxide to the first solution to produce a second solution; adding benzimidazole dissolved in methanol to the second solution to produce a third solution; and heating the third solution at a temperature greater than 100° C. to form the graphene oxide-zeolitic imidazolate framework nanocomposite.

In some embodiments, the amount of graphene oxide added to the first solution is less than 5 wt. % relative to a combined mass of the amount of hydrated zinc nitrate and the amount of benzimidazole.

In some embodiments, the amount of graphene oxide added to the first solution is about 1.6 wt. % relative to a combined mass of the amount of hydrated zinc nitrate and the amount of benzimidazole.

In some embodiments, the graphene oxide-zeolitic imidazolate framework nanocomposite was dried at 50° C.

In some embodiments, the method includes heating the third solution to a temperature of 130° C.

In some embodiments, the method includes heating the third solution for at least 24 hours.

In an exemplary embodiment, a water filtration composition, including the graphene oxide-zeolitic imidazolate framework nanocomposite, is described.

In an exemplary embodiment, a method for removing metal ions from water is described. The method includes mixing an amount of the graphene oxide-zeolitic imidazolate framework nanocomposite to a sample of water comprising one or more metal ions to form a solution; removing the one or more metal ions from the sample of water by adsorbing the one or more metal ions onto the graphene oxide-zeolitic imidazolate framework nanocomposite; and recovering the graphene oxide-zeolitic imidazolate framework nanocomposite.

In some embodiments, one or more metal ions include lead.

In some embodiments, the solution containing nanocomposite and metal ion solution is mixed for at least 24 hours.

In some embodiments, the amount of graphene oxide-zeolitic imidazolate framework nanocomposite has a Pb²⁺ ion uptake capacity ranging from 900 mg/L to 5,000 mg/L, where the Pb²⁺ ion uptake capacity is calculated according to:

$${q}_{e} = \frac{( {C}_{i} - {C}_{f} ) V}{m}$$

where Cᵢ and C_{f} are, respectively, initial and final lead concentrations, V is the sample volume, and m is the the amount of graphene oxide-zeolitic imidazolate framework nanocomposite.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method of preparing a graphene oxide-zeolitic imidazolate framework-based nanocomposite (GO@ZIF-7) including graphene oxide (GO), a zeolitic imidazolate framework (ZIF-7), according to certain embodiments;

FIG. 1B is a flowchart depicting a method of removing metal ions from water using the GO@ZIF-7 nanocomposite, according to certain embodiments;

FIG. 2 shows X-ray diffractogram (XRD) patterns of GO, ZIF-7, and the GO@ZIF-7 nanocomposite, according to certain embodiments;

FIG. 3A shows Fourier Transform Infrared (FTIR) spectra of GO@ZIF-7 nanocomposite, according to certain embodiments;

FIG. 3B shows FTIR spectra of ZIF-7, according to certain embodiments;

FIG. 3C shows FTIR spectra of GO, according to certain embodiments; and

FIG. 4 is a bar graph comparing the lead adsorption performance with GO, ZIF-7, and the GO@ZIF-7 nanocomposite, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, “particle size” may be thought of as the length or longest dimension of a particle.

As used herein, “nanocomposites” are solid materials that have multiple phase domains, and at least one of these domains has a nanoscale structure. The nanoparticles may exist in various morphological shapes, such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanofloweres, etc., and mixtures thereof.

As used herein, “adsorption capacity” refers to the amount of adsorbate taken up by the adsorbent per unit mass (or volume) of the adsorbent.

A weight percent of a component, unless specifically stated to the contrary, is based on the total weight of the formulation or composition in which the component is included. For example, if a particular element or component in a composition or article is said to have 5 wt %, it is understood that this percentage is in relation to a total compositional percentage of 100%.

Aspects of the present disclosure are directed to a graphene oxide-zeolitic imidazolate framework-based nanocomposite (GO@ZIF-7) or herein referred to as a “nanocomposite”. The nanocomposite was characterized by various analytical techniques, such as X-ray diffractogram (XRD) and Fourier Transform Infrared (FTIR); and was further evaluated for its potential in water decontamination applications. The nanocomposite of the present disclosure demonstrated a high lead removal at relatively low dosages of the adsorbent (i.e., GO@ZIF-7 nanocomposite). The process used herein to prepare the nanocomposite is effective at ambient conditions with minimal energy input and with no additional material inputs. The GO@ZIF-7 nanocomposite outperforms the pristine GO and ZIF-7 in terms of its performance for lead removal.

A nanocomposite is described. The nanocomposite includes graphene oxide and a zeolitic imidazolate framework (ZIF). Graphene oxide (GO) is a single-atomic-layered material, made by the oxidation of graphite, which is cheap, abundant, and widely used as an adsorbent in various water purification technologies. GO is an oxidized form of graphene, with an average particle size of less than 100 nm. It is laced with high concentrations of functional groups, such as the hydroxyl (C—OH), epoxyl (—O—), carboxylate (—COOH), or other oxygen-containing groups, at the edges and on the face of the GO nanosheets. The polar oxygen functional groups of GO render it hydrophilic so that it can be dispersible in water (and other solvents). In an embodiment, the GO has a weight percentage in a range of 0.5-5%, preferably 0.75 to 4.5 wt. %, preferably 1 to 4 wt. %, preferably 1.3 to 3.5 wt. %, preferably 1.5 to 3 wt. %, preferably 1.6 to 2 wt. %, preferably 1.6 wt. % based on the total mass of the nanocomposite.

ZIF on the other hand, is a class of metal-organic frameworks (MOFs) that are topologically isomorphic with zeolites. ZIFs are composed of tetrahedrally-coordinated transition metal ions (e.g., Fe, Co, Cu, Zn) connected by imidazolate linkers. Various ZIF's are known in the art, such as ZIF-1, ZIF-3, ZIF-7, ZIF-8, ZIF-9, ZIF-11, and ZIF-67. The ZIF may exist in various phases, such as phase I, phase II, phase III, and/or combinations thereof. In a preferred embodiment, the ZIF exists in phase III. The ZIF is preferably ZIF-7. The ZIF, preferably ZIF-7 is modified with GO in such a way that the ZIF encases the GO, to form the nanocomposite (GO@ZIF-7).

The ZIF may fully or partially encase the graphene oxide, e.g., the graphene oxide forms one or more layers inside the GIF. Preferably a major portion of the surface area of the GO is covered or encased with the ZIF. For example, at least 80% of the surface area of the GO is encased in or covered with ZIF, preferably at least 90%, at least 95% or the total surface area of the GO. The GO-ZIF nanocomposite may be represented as a core-shell structure in which the core is GO and the shell is ZIF. In some embodiments a portion of the GO protrude from or extends outside of a ZIF matrix. A GO functionalized with ionic or polar groups such as carboxylate groups, hydroxyl groups and/or epoxy groups may help direct metal ions to the surface of the surrounding ZIF for adsorption and/or sequestration out of an aqueous solution.

The nanocomposite has an average particle size of less than 500 nm, preferably in the range of 10-500, preferably 20-490, preferably 25-480, preferably 30-470, preferably 40-460, preferably 50-450, preferably 60-440, preferably 70-430, preferably 80-420, preferably 90-410, preferably 100-400, preferably 110-390, preferably 120-380, preferably 130-370, preferably 140-360, preferably 150-350, preferably 160-340, preferably 170-330, preferably 180-320, preferably 190-310, preferably 200-300, preferably 210-290, preferably 220-280, preferably 230-270, preferably 240-280, preferably 250-270, and preferably 255-260 nm.

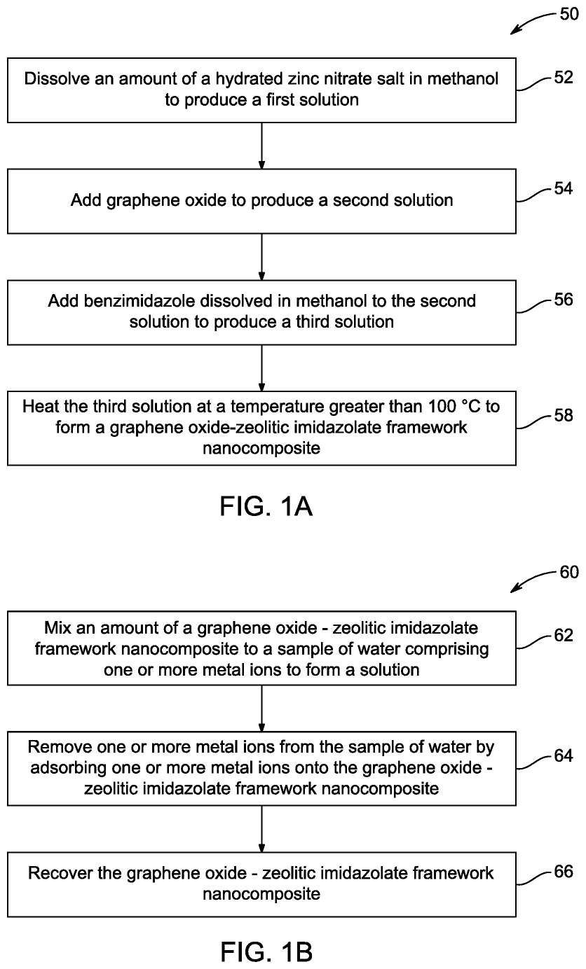

FIG. 1A illustrates a flow chart of method 50 of preparing a graphene oxide-zeolitic imidazolate framework nanocomposite. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dissolving an amount of a hydrated zinc nitrate salt in methanol to produce a first solution. Suitable examples of hydrated zinc salts include zinc sulfate heptahydrate (ZnSO₄·7H₂O), zinc nitrate hexahydrate (Zn(NO₃)₂·6H₂O), zinc acetate dihydrate (Zn(CH₃CO₂)₂), zinc oxalate dihydrate (ZnC₂O₄·2H₂O), zinc acetylacetonate hydrate Zn(C₅H₇O₂)2·xH₂O. In an embodiment, the hydrated zinc salt is Zn(NO₃)₂·6H₂O. In an embodiment, the hydrated zinc salt is a nitrate salt. In an embodiment, the hydrated zinc salt is Zn(NO₃)₂·6H₂O. In an embodiment, the concentration of the hydrated zinc salt in methanol is in a range of 0.1-0.3 g/mL, preferably 0.12 to 0.2 g/mL/, preferably 0.1485 g/mL. In an embodiment, other solvents, such as N, N-dimethylformamide (DMF), N-dimethylformamide (DEF), butanol, and the like, can be used as well instead of/in combination with methanol to produce the first solution.

At step 54, the method 50 includes adding graphene oxide to the first solution to produce a second solution. The weight ratio of the graphene oxide to the hydrated zinc salt in the first solution is in a range of 1:30 to 1:15, preferably 1:28 to 1:17, preferably 1:20 to 1:25. After the addition of the graphene oxide to the first solution, the first solution was stirred thoroughly to ensure uniform dissolution of the graphene oxide in the second solution. In an embodiment, the stirring was carried out using a stirrer for a period of 2-30 minutes, preferably 4-15 minutes, preferably 5-10 minutes, preferably 5 minutes, at room temperature (20-30° C.) to form the second solution. The graphene oxide in the second solution may be further exfoliated to produce single and multiple layers of graphene oxide by sonication. The sonication may be carried out using a probe sonicator (preferably) or an ultrasonic bath. Critical factors affecting the exfoliation process are the sonication time and power. In an embodiment, the second solution is sonicated with 50% amplitude for 10-60 minutes, preferably 20-50 minutes, preferably 30-40 minutes, and preferably 30 minutes.

At step 56, the method 50 includes adding benzimidazole dissolved in methanol to the second solution to produce a third solution. In an embodiment, the amount of graphene oxide added to the first solution is less than 5 wt. %, preferably 1-5 wt. %, preferably 1.2 to 4 wt. %, preferably 1.4 to 3 wt. %, preferably 1.5 to 2 wt. %, preferably 1.6 wt. % relative to a combined mass of the amount of hydrated zinc nitrate and the amount of benzimidazole.

At step 58, the method 50 includes heating the third solution at a temperature greater than 100° C. to form the graphene oxide-zeolitic imidazolate framework nanocomposite. In a specific embodiment, the third solution is heated to a temperature of 100-150° C., preferably 110-140° C., preferably 120-130° C., and more preferably 130° C. In a specific embodiment, the third solution is heated for 12-48 hours, preferably 15-40 hours, preferably 20-35 hours, preferably 24 hours, to form the graphene oxide-zeolitic imidazolate framework nanocomposite. The nanocomposite thus formed may be washed several times with an organic solvent, preferably methanol, to remove any impurities. The washed nanocomposite is further dried at 40-50° C. to allow for evaporation of the solvent. The drying may be carried out using heating appliances such as ovens, microwaves, autoclaves, hot plates, heating mantles and tapes, oil baths, salt baths, sand baths, air baths, hot-tube furnaces, and hot-air guns. The nanocomposite is further ground to a fine powder to reduce its particle size. The particle size may be reduced by ball milling, grinding, pressure homogenization, or a combination thereof. The small particle size of the nanocomposite imparts a high surface area and increased pore volume, resulting in an improved adsorptive capacity of the nanocomposite towards heavy metals, such as lead, when used for water purification applications.

In an embodiment, nanocomposites may be immobilized on a supporting material or substrate, such as, but not limited to, silica. The resultant supported composite is used for the removal of heavy metal waste from water. Suitable examples of supporting material include alumina, zeolites, activated carbon, cellulose fibers, coconut fibers, clay, banana silks, nylon, coconut shell, and a combination thereof.

Another aspect of the present disclosure relates to water filtration composition. The water filtration composition includes the GO@ZIF-7 nanocomposite. In an embodiment, metals/metal oxides thereof that can be incorporated into the water filtration composition include, without limitation, gold, silver, platinum, palladium, cobalt, manganese, iron, tellurium, rhodium, ruthenium, copper, iridium, molybdenum, chromium, cerium, or a combination thereof.

The nanocomposite of the present disclosure can be used for removing heavy metals from water. Examples of heavy metals include but are not limited to, lead (Pb(II)) and manganese (Mn(II)), copper (Cu(II)), nickel (Ni(II)), cadmium (Cd(II)) and mercury (Hg(II)). In a preferred embodiment, the nanocomposite is used to remove lead from water. Suitable examples of water sources can be any groundwater source, an industrial source, a municipal source, and/or a combination thereof.

FIG. 1B illustrates a flow chart of method 60 for removing metal ions from water. The order in which the method 60 is described is not intended to be construed as a limitation, and any number of the described method steps can be combined in any order to implement the method 60. Additionally, individual steps may be removed or skipped from the method 60 without departing from the spirit and scope of the present disclosure.

At step 62, the method 60 includes mixing an amount of the GO@ZIF-7 nanocomposite to a sample of water comprising one or more metal ions to form a solution. The water may include metal ions, such as lead (Pb(II)) and manganese (Mn(II)), copper (Cu(II)), nickel (Ni(II)), cadmium (Cd(II)), and mercury (Hg(II)). In a preferred embodiment, the nanocomposite is particularly effective for the removal of lead from water. The pH of the water is about 2-10, preferably 4-7.

At step 64, the method 60 includes removing one or more metal ions from the sample of water by adsorbing the one or more metal ions onto the GO@ZIF-7 nanocomposite. The nanocomposite is made to contact the water containing one or more metal ions for a sufficient period, such as 1 hour to 24 hours, to allow for adsorption of the metal ions to the nanocomposite. In some embodiments, the nanocomposite removes at least 50%, preferably at least 60%, preferably at least 70%, more preferably at least 80%, or more preferably at least 90%, or more preferably at least 95% of the metal ions in the water.

At step 66, method 60 includes recovering the GO@ZIF-7 nanocomposite. The nanocomposite with the metal ions adsorbed onto it is separated from water via filtration or any other methods known in the art. The metal ions are further adsorbed onto the nanocomposite are desorbed via thermal or solvent desorption techniques to recover the nanocomposite. In an embodiment, the recovered nanocomposite can be used multiple times without compromising on the efficiency for up to 5-20 cycles.

The nanocomposite of the present disclosure has a Pb²⁺ ion uptake capacity ranging from 900 mg/L to 5,000 mg/L, where the Pb²⁺ ion uptake capacity is calculated according to:

$${q}_{e} = \frac{( {C}_{i} - {C}_{f} ) V}{m}$$

where Cᵢ and C_{f} are, respectively, an initial and a final lead concentrations, V is the sample volume, and m is the amount of graphene oxide-zeolitic imidazolate framework nanocomposite.

### EXAMPLES

The following examples demonstrate a graphene oxide-zeolitic imidazolate framework-based nanocomposite as described herein. The examples are provided solely for illustration and are not to be construed as limitations of the present disclosure, as many variations thereof are possible without departing from the spirit and scope of the present disclosure.

### Example 1: Synthesis of Graphene Oxide (GO)

GO was prepared according to the improved Hummers method [Marcano, D. C., Kosynkin, D. V, Berlin, J. M., Sinitskii, A., Sun, Z., Slesarev, A., Alemany, L. B., Lu, W., & Tour, J. M. (2010). Improved Synthesis of Graphene Oxide. ACS Nano, 4(8), 4806-4814—incorporated herein by reference]. Briefly, 360 mL of H₂SO₄ and 40 mL of H₃PO₄ (H₂SO₄:H₃PO₄ volumetric ratio=9:1) were carefully mixed in a flask. To regulate the temperature, the flask was placed in an ice bath. Then, 3 g of graphite powder was added to the above mixture, followed by the slow addition of 18 g KMnO₄ while continuously stirring. The reaction mixture was then transferred to a warm water bath and stirred for 12 h at 50° C. After that, the reaction mixture was poured into about 400 g of crushed ice, followed by the slow addition of H₂O₂ (˜5 mL) until the mixture color turned dark yellow. Then, the mixture was stirred continuously for 12 h at room temperature. The mixture was, then, washed consecutively with distilled water and HCl (10 vol %) solution three times each, and the solid was recovered after each wash cycle by centrifugation at 8000 rpm. After this step, GO was further rinsed several times with a copious amount of distilled water to remove the acid. Finally, the obtained GO was dried at 50° C. and ground to produce fine powders.

### Example 2: Synthesis of Zeolitic Imidazolate Framework-7 (ZIF-7)

The preparation of ZIF-7 was according to the protocol reported by Yaghi group, with some modifications [Morris, W., He, N., Ray, K. G., Klonowski, P., Furukawa, H., Daniels, I. N., Houndonougbo, Y. A., Asta, M., Yaghi, O. M., & Laird, B. B. (2012). A Combined Experimental-Computational Study on the Effect of Topology on Carbon Dioxide Adsorption in Zeolitic Imidazolate Frameworks. The Journal of Physical Chemistry C, 116(45), 24084-24090—incorporated herein by reference]. In this preparation, 5.94 g of Zn(NO₃)₂·6H₂O was added to 40 mL HPLC grade methanol. In a separate beaker, 9.44 g benzimidazole was added to 40 mL high-performance liquid chromatography (HPLC) grade methanol. The two solutions were then stirred at room temperature until the solid materials (Zn(NO₃)₂·6H₂O and benzimidazole) were completely dissolved. After that, the zinc solution was poured quickly into the benzimidazole solution while stirring for 1 h at room temperature. The mixture was then transferred into a Teflon-lined autoclave reactor and kept in an oven at 130° C. for 24 h. Then, the autoclave reactor was removed from the oven and left to cool down naturally. Following that, the formed ZIF-7 powder was purified via several washes with HPLC-grade methanol; the solid ZIF-7 material was recovered after each wash using centrifugation at 6000 rpm. The purified ZIF-7 was then dried at 50° C. The dried ZIF-7 powder was ground to obtain a fine powder. The ZIF-7 powder was stored in tightly closed containers until use.

### Example 3: Synthesis of GO@ZIF-7 Nanocomposite

To prepare GO@ZIF-7 nanocomposite, 5.94 g Zn(NO₃)₂·6H₂O was added to 40 mL HPLC grade methanol, followed by stirring until the zinc salt was completely dissolved. Then, 0.25 g GO was added to the above solution and stirred at room temperature for 5 min to disperse GO. After that, the GO dispersion was sonicated at 50% amplitude for 30 min (30 seconds pulse on/3 seconds off) using a probe sonicator. The remaining preparation steps are similar to those described in Example 2. The synthesized samples are characterized by various analytical techniques, and they were further evaluated for their potential in water decontamination.

### Results and Discussion

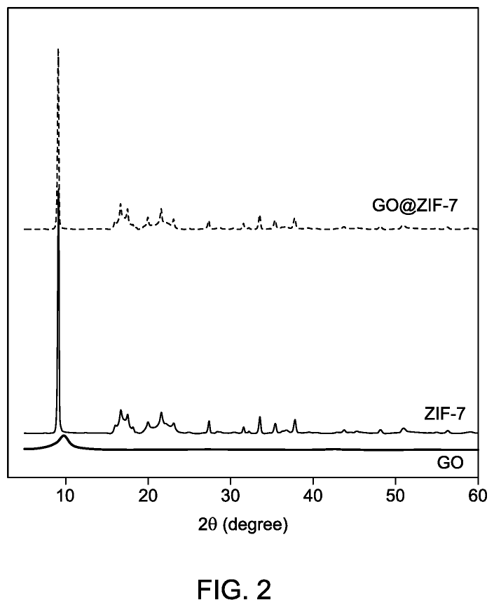

FIG. 2 compares the X-ray diffractogram (XRD) pattern of the GO@ZIF-7 nanocomposite to those of ZIF-7 and GO. The diffraction peaks of ZIF-7 appear at 2θ of 9.12, 16.0, 16.68, 17.52, 19.98, 21.6, 23.1, 27.39, 31.59, 33.54, 35.43, and 37.8° are in line with those observed for ZIF-7 prepared using diethyl formamide [Polyakov, V. A., Butova, V. V, Erofeeva, E. A., Tereshchenko, A. A., & Soldatov, A. V. (2020). MW Synthesis of ZIF-7. The Effect of Solvent on Particle Size and Hydrogen Sorption Properties. In Energies (Vol. 13, Issue 23)—incorporated herein by reference], ammonia atmosphere [Ebrahimi, M., & Mansournia, M. (2017). Rapid room temperature synthesis of zeolitic imidazolate framework-7 (ZIF-7) microcrystals. Materials Letters, 189, 243-247—incorporated herein by reference], water/ethanol mixture [He, M., Yao, J., Li, L., Wang, K., Chen, F., & Wang, H. (2013). Synthesis of Zeolitic Imidazolate Framework-7 in a Water/Ethanol Mixture and Its Ethanol-Induced Reversible Phase Transition. ChemPlusChem, 78(10), 1222-1225], and N,N-dimethylformamide [Sarango, L., Benito, J., Gascón, I., Zornoza, B., & Coronas, J. (2018). Homogeneous thin coatings of zeolitic imidazolate frameworks prepared on quartz crystal sensors for CO₂ adsorption. Microporous and Mesoporous Materials, 272, 44-52—incorporated herein by reference] as the synthesis medium. The sharp and intense characteristic diffraction peak at 9.12° is indicative of the formation of microporous ZIF-7 [He, M., Yao, J., Li, L., Wang, K., Chen, F., & Wang, H. (2013). Synthesis of Zeolitic Imidazolate Framework-7 in a Water/Ethanol Mixture and Its Ethanol-Induced Reversible Phase Transition. ChemPlusChem, 78(10), 1222-1225—incorporated herein by reference]. Based on the synthesis conditions and medium, ZIF-7 might exist as phase I, II, or III. The diffraction peaks of ZIF-7 shown in FIG. 2 indicate the formation of ZIF-7 phase III. The above-cited references also reported the formation of ZIF-7 phase III. This ZIF-7 phase has a (4,4) square planar with a rigid structure formed via the coordination of benzimidazolate tetrahedra with quadruply linked corner-shared networks of Zn(II). Although the ZIF-7 III phase is the densest among other ZIF-7 phases (and also many other ZIFs), it is the most stable phase of ZIF-7 [Zhao, P., Lampronti, G. I., Lloyd, G. O., Wharmby, M. T., Facq, S., Cheetham, A. K., & Redfern, S. A. T. (2014). Phase Transitions in Zeolitic Imidazolate Framework 7: The Importance of Framework Flexibility and Guest-Induced Instability. Chemistry of Materials, 26(5), 1767-1769—incorporated herein by reference].

FIG. 2 also shows the XRD diffraction pattern of GO, which reveals a single minor diffraction peak at 9.8°. This GO diffraction pattern is in line with the relevant literature on GO prepared using the improved Hummers method [Ibrahim, A., Vohra, M. S., Bahadi, S. A., Onaizi, S. A., Essa, M. H., & Mohammed, T. (2022). Heavy metals adsorption onto graphene oxide: effect of mixed systems anresponse surface methodology modeling. Desalination and Water Treatment, 266, 78-90, Yasin, G., Arif, M., Shakeel, M., Dun, Y., Zuo, Y., Khan, W. Q., Tang, Y., Khan, A., & Nadeem, M. (2018). Exploring the Nickel-Graphene Nanocomposite Coatings for Superior Corrosion Resistance: Manipulating the Effect of Deposition Current Density on its Morphology, Mechanical Properties, and Erosion-Corrosion Performance. Advanced Engineering Materials, 20(7), 1701166—each incorporated herein by reference]. Additionally, FIG. 2 displays the XRD pattern of the GO@ZIF-7 nanocomposite. From FIG. 2, it can be observed that the XRD patterns of ZIF-7 and GO@ZIF-7 nanocomposite is similar. This similarity is justified by the low intensity of the GO diffraction peak at 9.8°, which is about 5% of the intensity of the ZIF-7 peak appearing at close proximity (i.e., at 2θ angle of 9.12°). The close proximity of the minor GO and the intense ZIF-7 diffraction peaks could result in concealing the diffraction peak of GO by that of ZIF-7. Additionally, the low level of GO in the GO@ZIF-7 nanocomposite (about 1.63% of the mass of the ZIF-7 precursors) is another plausible reason for the similarity of the XRD diffraction patterns of ZIF-7 and GO@ZIF-7 nanocomposite.

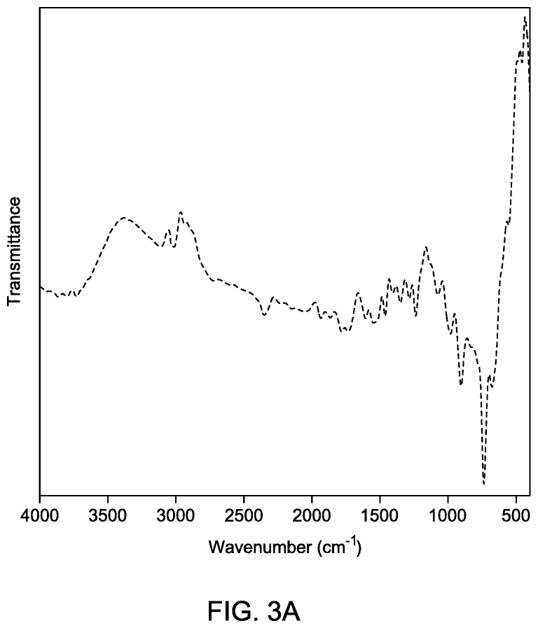

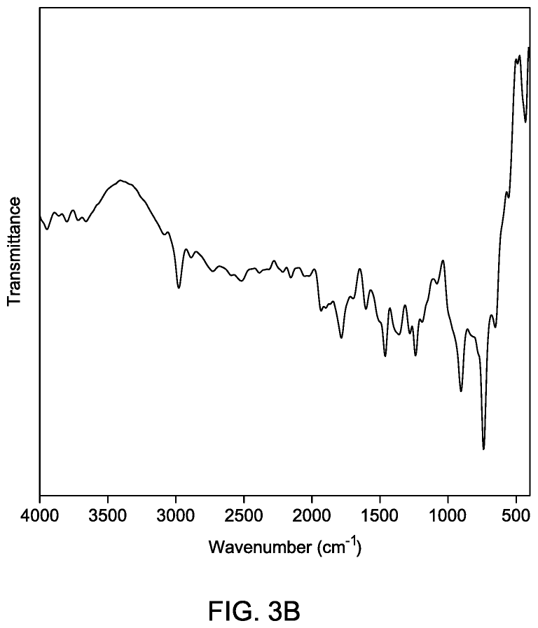

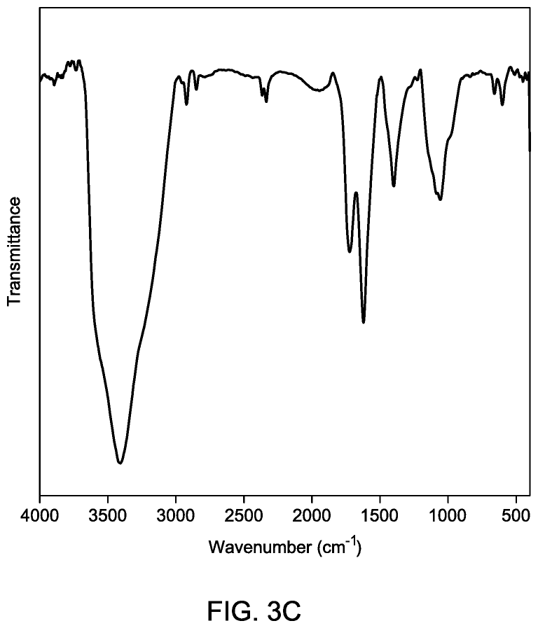

The Fourier Transform Infrared (FTIR) spectra of GO@ZIF-7 nanocomposite, ZIF-7, and GO and is shown in FIGS. 3A-3C, respectively. As shown in FIG. 3C, GO spectra have a wide and intense absorption peak at around 3417 cm⁻¹, which corresponds to the O—H stretching vibration due to the presence of water moisture and/or the KBr deliquescence [Al-Fakih, A., Ahmed Al-Koshab, M. Q., Al-Awsh, W., Drmosh, Q. A., Al-Osta, M. A., Al-Shugaa, M. A., & Onaizi, S. A. (2022). Mechanical, hydration, and microstructural behavior of cement paste incorporating Zeolitic imidazolate Framework-67 (ZIF-67) nanoparticles. Construction and Building Materials, 348, 128675; and Al-Fakih, A., Al-Awsh, W., Ahmed Al-Koshab, M. Q., Al-Shugaa, M. A., Al-Osta, M. A., Drmosh, Q. A., Musa, A. E. S., Abdulgader, M. A., Elgzoly, M. A. A., & Onaizi, S. A. (2023). Effects of zeolitic imidazolate framework-8 nanoparticles on physicomechanical properties and microstructure of limestone calcined clay cement mortar. Construction and Building Materials, 366, 130236—incorporated herein by reference]. The minor peaks at 2936 and 2855 cm⁻¹ are attributed to the bending vibration of the C—H bond in the GO framework [Liu, Y., Sajjadi, B., Chen, W.-Y., & Chatterjee, R. (2019). Ultrasound-assisted amine functionalized graphene oxide for enhanced CO₂ adsorption. Fuel, 247, 10-18; and Al-Qadri, A. A. Q., Drmosh, Q. A., & Onaizi, S. A. (2022). Enhancement of bisphenol a removal from wastewater via the covalent functionalization of graphene oxide with short amine molecules. Case Studies in Chemical and Environmental Engineering, 6, 100233—incorporated herein by reference]. Additionally, the peak at 1730 cm⁻¹ corresponds to the C═O stretching vibration while the relative intensity peak at 1636 cm⁻¹ is related to the skeletal vibration of the sp² hybridized carbons in the graphitic structure in Environmental Remediation Process. Furthermore, the absorption peaks a 1385 and 1060 cm⁻¹ corresponds to the bending of the alcohol bond (O—H) and the C—H stretching vibration, respectively.

The ZIF-7 spectra shown in FIG. 3B are comparable to those reported by Davoodian et al. [Davoodian, N., Nakhaei Pour, A., Izadyar, M., Mohammadi, A., Salimi, A., & Kamali Shahri, S. M. (2020). Fischer-Tropsch synthesis using zeolitic imidazolate framework (ZIF-7 and ZIF-8)-supported cobalt catalysts. Applied Organometallic Chemistry, 34(9), e5747], Zhao et al. [Zhao, Y.-T., Yu, L.-Q., Xia, X., Yang, X.-Y., Hu, W., & Lv, Y.-K. (2018). Evaluation of the adsorption and desorption properties of zeolitic imidazolate framework-7 for volatile organic compounds through thermal desorption-gas chromatography. Analytical Methods, 10(40), 4894-4901] and Li et al. [Li, F., Li, Q., Bao, X., Gui, J., & Yu, X. (2014). Preparation and gas permeability of ZIF-7 membranes prepared via two-step crystallization technique. Korean Chemical Engineering Research, 52(3), 340-346—each incorporated herein by reference]. Additionally, the FTIR spectra of ZIF-7 and GO@ZIF-7 nanocomposite is comparable, most likely due to the low level of GO in the nanocomposite. Nonetheless, despite this low GO level, the inclusion of GO in the ZIF-7 framework resulted in a significant increase in lead adsorption. The FTIR spectra of ZIF-7 and GO@ZIF-7 nanocomposite shown in FIG. 3B and FIG. 3A, respectively, displays several absorption peaks. The peaks appearing at around 2700-3100 cm⁻¹ might be attributed to the O—H stretching vibration of the residual alcohol used in the synthesis and purification. The absorption peaks at 1700-2000 cm⁻¹ could be assigned to the bending vibration of the C—H bond in the benzyl ring of the organic linker (i.e., benzimidazole) while the absorption peaks at 1500-1700 cm⁻¹ can be ascribed the C═C stretching of the aromatic ring of the benzimidazole. The peaks at 1300-1365 cm⁻¹ might be attributed to the C—N stretching while the peak appearing at around 1240 cm⁻¹ stems from the C—C stretching. The absorption peaks at ˜1100-1200 and ˜740-900 cm⁻¹ can be attributed to the in-plane and out-of-plane bending vibration of the C—H, respectively. The peak appearing at around 1080 might be related to the C—C—C trigonal bending of the organic linker. The peaks at ˜450-550 cm⁻¹ can be ascribed to the C—C—C out-of-plane bending vibration while the one at ˜650 cm⁻¹ is related to the C—C—C in-plane bending vibration. The peak centered at ˜430 is due to the stretching vibration of the formed Zn—N bond between the organic linker and the Zn atom.

### Water Decontamination Tests

The adsorption performance of GO@ZIF-7 was compared to those of GO and ZIF-7. In these experiments, the adsorbent dosage, sample volume, adsorption time, and shaking speed were fixed at 100 mg/L, 100 mL, 24 h, and 250 rpm, respectively. Two lead concentrations (100 and 500 mg/L) were prepared using distilled water and utilized in these experiments to measure the lead uptake capacity by the above 3 adsorbents. The uptake capacity (qₑ) was calculated using the following equation:

$${q}_{e} = \frac{( {C}_{i} - {C}_{f} ) V}{m}$$

Where Cᵢ and C_{f} are, respectively, the initial and final (after 24 h) lead concentrations, V is the sample volume, and m is the adsorbent mass.

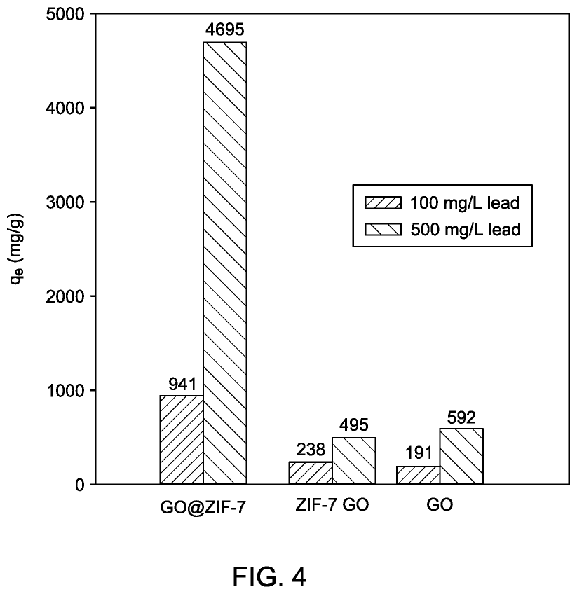

The adsorption of lead on GO, ZIF-7, and GO@ZIF-7 nanocomposite is shown in FIG. 4. As can be observed from FIG. 4, the adsorption capacity of lead on GO@ZIF-7 nanocomposite is 941 mg/g when the adsorption took place from 100 mg/L lead solution. This lead uptake capacity by the GO@ZIF-7 nanocomposite is about 4-fold higher than its adsorption on the parental materials (i.e., GO and ZIF-7) of the nanocomposite. Increasing the initial lead concentration to 500 mg/L resulted in a huge boost in lead adsorption capacity by the GO@ZIF-7 nanocomposite, reaching 4695 mg/g, which is almost 10 times higher than its adsorption capacity by GO and ZIF-7. These results demonstrate the superiority of the GO@ZIF-7 nanocomposite relative to GO and ZIF-7. The results demonstrate the industrial and practical potential of GO@ZIF-7 nanocomposite for wastewater treatment, as revealed by the very high lead uptake capacity and the successful treatment of respective lead-contaminated water.

Numerous modifications and variations of the present invention are possible in light of the above teachings. It is therefore to be understood that within the scope of the appended claims, the invention may be practiced otherwise than as specifically described herein.

What is claimed is:

1. A method for removing metal ions from water, comprising:
mixing an amount of a graphene oxide-zeolitic imidazolate framework (GO-ZIF) nanocomposite with an aqueous composition comprising one or more metal ions to form a treatment solution;
adsorbing the one or more metal ions onto the GO-ZIF nanocomposite;
wherein the GO-ZIF nanocomposite comprises:
graphene oxide, and
a zeolitic imidazolate framework (ZIF),
wherein the zeolitic imidazolate framework has a phase III structure and at least partially encases the graphene oxide.

2. The method according to claim 1, wherein the GO-ZIF nanocomposite comprises ZIF-7.

3. The method according to claim 1, wherein the graphene oxide is fully encased by the zeolitic imidazolate framework.

4. The method according to claim 1, wherein the GO-ZIF nanocomposite comprises less than 5 wt % graphene oxide based on the total weight of the GO-ZIF nanocomposite.

5. The method according to claim 1, wherein the GO-ZIF nanocomposite comprises about 1.6 wt % graphene oxide based on the total weight of the GO-ZIF nanocomposite.

6. The method according to claim 1, wherein the GO-ZIF nanocomposite has an average particle size of less than 500 nm.

7. The method according to claim 1, wherein the graphene oxide has carboxylate functional groups.

8. The method according to claim 1, wherein the GO-ZIF nanocomposite has a Pb²⁺ ion uptake capacity ranging from 900 mg/L to 5,000 mg/L, where the Pb²⁺ ion uptake capacity is calculated according to:
$${q}_{e} = \frac{( {C}_{i} - {C}_{f} ) V}{m}$$
where Cᵢ and C_{f} are, respectively, an initial and a final lead concentrations, V is the sample volume, and m is the amount of graphene oxide-zeolitic imidazolate framework nanocomposite.

9. The method according to claim 1, wherein the GO-ZIF nanocomposite is in the form of a core-shell particle with a zeolitic imidazolate framework shell and a graphene oxide core.

10. The method of claim 1, further comprising:
forming the GO-ZIF nanocomposite by:
dissolving an amount of a hydrated zinc nitrate salt in methanol to produce a first solution;
adding a graphene oxide powder to the first solution to produce a second solution;
adding benzimidazole dissolved in methanol to the second solution to produce a third solution; and
heating the third solution at a temperature greater than 100° C. to form the GO-ZIF nanocomposite.

11. The method according to claim 10, wherein the amount of graphene oxide added to the first solution is less than 5 wt % relative to a combined mass of the amount of hydrated zinc nitrate and the amount of benzimidazole.

12. The method according to claim 10, wherein the amount of graphene oxide added to the first solution is about 1.6 wt % relative to a combined mass of the amount of hydrated zinc nitrate and the amount of benzimidazole.

13. The method according to claim 10, further comprising
drying the GO-ZIF nanocomposite at 50° C.

14. The method according to claim 10, wherein the third solution is heated to a temperature of 130° C.

15. The method according to claim 10, wherein the third solution is heated for at least 24 hours.

16. The method according to claim 1, wherein the aqueous composition comprises lead.

17. The method according to claim 15, wherein the third solution is heated for at least 24 hours.
